(19) United States
(12) Patent Application Publication
(10) Pub. No.: US 2025/0377340 A1
(43) Pub. Date: Dec. 11, 2025

(54) ACOUSTIC EMISSION BASED STRUCTURAL HEALTH AND DAMAGE DETECTION AND MONITORING SYSTEMS AND METHODS

(71) Applicant: North Carolina A&T State University, Greensboro, NC (US)

(72) Inventors: Mannur J. Sundaresan, Greensboro, NC (US); David Amoateng-Mensah, Greensboro, NC (US); Manoj Rijal, Greensboro, NC (US); Travis ObieRolle, Greensboro, NC (US)

(21) Appl. No.: 19/230,156

(22) Filed: Jun. 6, 2025

Related U.S. Application Data
(60) Provisional application No. 63/656,840, filed on Jun. 6, 2024.

(51) Int. Cl. G01N 29/14; G01N 29/04

(52) U.S. Cl. CPC G01N 29/14; G01N 29/041; G01N 2291/2694

(57) ABSTRACT

Systems and methods for monitoring structural integrity are provided. Acoustic sensors are disposed in relation to an area of interest of a structural member to detect an acoustic emission and output an acoustic emission signal. The signal is collected, and a computing device evaluates acoustic emission signal characteristics and predicts whether a crack is present. The acoustic emission signal characteristics are used to detect and predict aspects associated with formation and growth of cracks at various locations of the structural member.

### CROSS-REFERENCE TO RELATED APPLICATIONS

This application claims priority to U.S. Provisional Application No. 63/656,840, filed Jun. 6, 2024, the disclosure of which is incorporated by reference herein in its entirety.

### STATEMENT OF GOVERNMENT RIGHTS

This invention was made with government support under AWD-002709-G1 awarded by the National Aeronautics and Space Administration. The government has certain rights in the invention.

### FIELD

The present disclosure relates generally to systems and methods for assessing structural integrity, more particularly, to detecting and monitoring structural health and damage using acoustic emissions.

### BACKGROUND

As with other structural health monitoring (“SHM”) methods, an objective of Acoustic emission (“AE”) monitoring systems is to detect the rate of crack growth, estimate residual strength, and predict a life expectancy of structures. Advances in sensors, electronics, and signal processing technologies have improved component reliability and performance. However, an accurate understanding of the relationship between the energy of acoustic emission events and the magnitude of their source is required to enable AE monitoring systems that have the potential to continuously monitor damage development in structures, while in service. With said understanding, AE techniques can be deployed in a variety of applications.

In general, attempts by those skilled in the art have been made to accurately determine the crack growth rate of microcracks through sensing acoustic emissions where known solutions have not been effective.

### SUMMARY

In one aspect of the disclosed technology, a system for monitoring structural integrity includes a structural member and one or more acoustic sensors disposed in relation to an area of interest of the structural member. Each acoustic sensor is configured to detect an acoustic emission associated with the area of interest, produce an acoustic emission signal associated with the acoustic emission, and output the acoustic emission signal. The system for monitoring structural integrity further includes a data acquisition device that is configured to collect the acoustic emission signal output by the one or more acoustic sensors and output the acoustic emission signal as a dataset. The system for monitoring structural integrity also includes a computing device, including a processor and a memory that are configured to store programming instructions. The programming instructions, when executed by the processor, are configured to cause the processor to receive the dataset into memory, determine acoustic emission signal characteristics associated with the dataset, and analyze the acoustic emission signal characteristics to predict whether a crack associated with the structural member is present.

In another aspect of the present disclosure, the one or more sensors are positioned to receive the acoustic emissions associated with a crack internal to the structural member.

In another aspect of the present disclosure, each acoustic sensor is disposed at a distance relative to the area of interest.

In another aspect of the present disclosure, each acoustic sensor is disposed at a distance extending in an angular direction in relation to the area of interest.

In another aspect of the present disclosure, the angular direction includes at least one of ninety degrees, sixty-three degrees, or forty-five degrees, each referenced from a horizontal centerline of the area or interest.

In another aspect of the present disclosure, the one or more acoustic sensors include at least one of a piezoelectric material or a fiber optic material.

In another aspect of the present disclosure the acoustic emission signal characteristics include a symmetric mode of a Lamb waveform and an antisymmetric mode of the Lamb waveform

In another aspect of the present disclosure, the antisymmetric mode is filtered, removed, minimized, or ignored.

In another aspect of the present disclosure, the acoustic emission signal characteristics includes a shear horizontal waveform.

In another aspect of the present disclosure, the acoustic emission signal characteristics include an energy value of the crack, the energy value determined from a magnitude of the symmetric mode.

In another aspect of the present disclosure, the acoustic emission signal characteristics include a symmetric mode of a Lamb waveform associated with the acoustic emission signal, and the computing device is further configured to rectify the symmetric mode, square the rectified symmetric mode, fit an envelope to the rectified and squared symmetric mode, determine an area enclosed by the envelope, correlate the area to an energy value, and use the energy value to predict growth rate of the crack.

In another aspect of the present disclosure, the acoustic signal characteristics are used to predict a location of the crack in relation to a reference point of the structural member

In another aspect of the present disclosure, the computing device is configured to predict a symmetric mode of a Lamb waveform associated with the acoustic emission signal.

In another aspect of the present disclosure, the acoustic signal characteristics are used to determine crack growth rate.

In another aspect of the present disclosure, the computing device is further configured to generate an action in response when characteristics associated with a predicted crack exceed a threshold value.

In another aspect of the present disclosure, a method for monitoring structural integrity includes disposing one or more acoustic sensors in relation to an area of interest of a structural member. Each acoustic sensor is configured to detect an acoustic emission associated with the area of interest, produce an acoustic emission signal associated with the acoustic emission, and output the acoustic emission signal. The method for monitoring structural integrity further includes using a data acquisition device. The data acquisition device is configured to collect the acoustic emission signal output by the one or more acoustic sensors and output the acoustic emission signal as a dataset. The method for monitoring structural integrity also includes using a computing device, including a processor and a memory configured to store programming instructions. The programming instructions, when executed by the processor, are configured to cause the processor to receive the dataset into memory, determine acoustic emission signal characteristics associated with the dataset, and analyze the acoustic emission signal characteristics to predict whether a crack associated with the structural member is present

In another aspect of the present disclosure, the acoustic emission includes a symmetric mode of a Lamb waveform and an antisymmetric mode of the Lamb waveform.

In another aspect of the present disclosure, the antisymmetric mode is filtered, removed, minimized, or ignored.

In another aspect of the present disclosure, the method for monitoring structural integrity further includes using the acoustic signal characteristics to predict a location of the crack in relation to a reference point of the structural member.

In another aspect of the present disclosure, the acoustic emission signal characteristics include a symmetric mode of a Lamb waveform associated with the acoustic emission signal, and the computing device is further configured to rectify the symmetric mode, square the rectified symmetric mode, fit an envelope to the rectified and squared symmetric mode, determine an area enclosed by the envelope, correlate the area to an energy value, and use the energy value to predict growth rate of the crack.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated herein and constitute part of this specification, are illustrative of particular embodiments of the present disclosure and do not limit the scope of the present disclosure. The drawings are not to scale and are intended for use in conjunction with the explanations in the following detailed description.

FIG. 1 is a schematic representation of a beam showing centrally located acoustic emission sources;

FIG. 2A is a graph of an example integrated sinusoidal pulse, which can be used to simulate the formation of a microcrack in the beam depicted in FIG. 1;

FIG. 2B is a graph of the frequency content of the example integrated sinusoidal pulse depicted in FIG. 2A;

FIG. 3A is a graph of an example axial strain waveform associated with the formation of the microcrack at a neutral axis of the beam of FIG. 1 with a bar thickness of 3 mm, received at a 100 mm source-to-sensor distance;

FIG. 3B is a graph of an example normal displacement waveform associated with the formation of the microcrack at the neutral axis of the beam of FIG. 1 with a bar thickness of 3 mm, received at the 100 mm source-to-sensor distance;

FIG. 4A is a graph of an example axial strain waveform associated with the formation of the microcrack at a 1.5 mm transverse offset from the neutral axis of the beam of FIG. 1 with a bar thickness of 3 mm, received at the 300 mm source-to-sensor distance;

FIG. 4B is a graph of an example normal displacement waveform associated with the formation of the microcrack at the 1.5 mm transverse offset from the neutral axis of the beam of FIG. 1 with a bar thickness of 3 mm, received at the 300 mm source-to-sensor distance;

FIG. 5A is a graph of an example axial strain waveform associated with the formation of the microcrack at a neutral axis of the beam of FIG. 1 with a bar thickness of 3 mm, received at a 300 mm source-to-sensor distance;

FIG. 5B is a graph of an example normal displacement waveform associated with the formation of the microcrack at the neutral axis of the beam of FIG. 1 with a bar thickness of 3 mm, received at the 300 mm source-to-sensor distance;

FIG. 6A is a graph of an example axial strain waveform associated with the formation of the microcrack at a 1.5 mm transverse offset from the neutral axis of the beam of FIG. 1 with a bar thickness of 3 mm, received at the 300 mm source-to-sensor distance;

FIG. 6B is a graph of an example normal displacement waveform associated with the formation of the microcrack at the 1.5 mm transverse offset from the neutral axis of the beam of FIG. 1 with a bar thickness of 3 mm, received at the 300 mm source-to-sensor distance;

FIG. 7A is a graph of example axial strain waveforms associated with the formation of the microcracks at various transverse offsets from the neutral axis of the beam of FIG. 1 with a bar thickness of 3 mm, received at the 100 mm source-to-sensor distance;

FIG. 7B is a graph of example normal displacement waveforms associated with the formation of the microcracks at various transverse offsets from the neutral axis of the beam of FIG. 1 with a bar thickness of 3 mm, received at the 100 mm source-to-sensor distance;

FIG. 8A is a graph of example maximum amplitude axial strain waveforms associated with the formation of the microcrack at a neutral axis of the beam of FIG. 1 with a bar thickness of 3 mm, received at various source-to-sensor distances;

FIG. 8B is a graph of example maximum amplitude normal displacement waveforms associated with the formation of the microcrack at a neutral axis of the beam of FIG. 1 with a bar thickness of 3 mm, received at various source-to-sensor distances;

FIG. 9A is a graph of an example rectified acoustic emission waveform associated with normal displacement of the microcrack;

FIG. 9B is a graph of an example envelope fitted over the rectified and squared waveform of FIG. 9A;

FIG. 10 is a graph of example loads versus displacements associated with impulses used to simulate acoustic emission events in the beam of FIG. 1 with a bar thickness of 3 mm, for two positions of the source event;

FIG. 11A is a graph of example acoustic emission energy related to normalized axial strain energy associated with the formation of the microcrack at various transverse offset distances from the neutral axis of the beam of FIG. 1 with a bar thickness of 2 mm, received at different source-to-sensor distances;

FIG. 11B is a graph of example acoustic emission energy related to normalized normal displacement energy associated with the formation of the microcrack at various transverse offset distances from the neutral axis of the beam of FIG. 1 with a bar thickness of 2 mm, received at different source-to-sensor distances;

FIG. 12A is a graph of example acoustic emission energy related to normalized axial strain energy associated with the formation of the microcrack at various transverse offset distances from the neutral axis of the beam of FIG. 1 with a bar thickness of 3 mm, received at different source-to-sensor distances;

FIG. 12B is a graph of example acoustic emission energy related to normalized normal displacement energy associated with the formation of the microcrack at various transverse offset distances from the neutral axis of the beam of FIG. 1 with a bar thickness of 3 mm, received at different source-to-sensor distances;

FIG. 13A is a graph of example acoustic emission energy related to normalized axial strain energy associated with the formation of the microcrack at various transverse offset distances from the neutral axis of the beam of FIG. 1 with a bar thickness of 5 mm, received at different source-to-sensor distances;

FIG. 13B is a graph of example acoustic emission energy related to normalized normal displacement energy associated with the formation of the microcrack at various transverse offset distances from the neutral axis of the beam of FIG. 1 with a bar thickness of 5 mm, received at different source-to-sensor distances;

FIG. 14A is a graph of example variations of measured acoustic emission energy related to axial strain and normal displacement associated with simulated acoustic energy sources at the neutral axis of the beam of FIG. 1 with a bar thickness of 3 mm, received at different source-to-sensor locations along the length of the beam;

FIG. 14B is a graph of example variations of measured acoustic emission energy related to axial strain and normal displacement associated with simulated acoustic energy sources at the at a top surface of the beam of FIG. 1 with a bar thickness of 3 mm, received at different source-to-sensor locations along the length of the beam;

FIG. 15A is a graph of example variations of acoustic emission energy related to normalized axial strain energy associated with the formation of the microcrack at various transverse offset distances from the neutral axis of the beam of FIG. 1 with a bar thickness of 3 mm, received at a 200 mm source-to-sensor distance;

FIG. 15B is a graph of example variations of acoustic emission energy related to normalized normal displacement energy associated with the formation of the microcrack at various transverse offset distances from the neutral axis of the beam of FIG. 1 with a bar thickness of 3 mm, received at a 200 mm source-to-sensor distance;

FIG. 16 is a graph of example ratios of acoustic emission energies detected by normal displacement energy and axial strain energy waveforms associated with a source at the top surface of the beam relative to the same source at the neutral axis of the beam of FIG. 1 with various bar thicknesses;

FIG. 17A is a graph of an example waveform associated with a 0.5 mm lead break test conducted at a neutral axis of a plate, as detected by a bonded sensor placed at a 100 mm distance from an edge of the plate;

FIG. 17B is a graph of an example waveform associated with the 0.5 mm lead break test conducted at the neutral axis of the plate of FIG. 17A, as detected by a bonded sensor placed at a 150 mm distance from an edge of the plate;

FIG. 17C is a graph of an example waveform associated with the 0.5 mm lead break test conducted at the neutral axis of the plate of FIG. 17A-B, as detected by a wide band sensor placed at the 150 mm distance from an edge of the plate;

FIG. 17D is a graph of an example waveform associated with the 0.5 mm lead break test conducted at the neutral axis of the plate of FIG. 17A-C, as detected by a 300 kHz sensor placed at the 150 mm distance from an edge of the plate;

FIG. 18A is a graph of an example waveform associated with a 0.5 mm lead break test conducted near an outer edge of a thickness of the plate of FIG. 17A-D, as detected by a bonded sensor placed at a 100 mm distance from an edge of the plate;

FIG. 18B is a graph of an example waveform associated with the 0.5 mm lead break test conducted at the outer edge of the thickness of the plate of FIG. 18A, as detected by a bonded sensor placed at a 150 mm distance from an edge of the plate;

FIG. 18C is a graph of an example waveform associated with the 0.5 mm lead break test conducted at the outer edge of the thickness of the plate of FIG. 18A-B, as detected by a wide band sensor placed at the 150 mm distance from an edge of the plate;

FIG. 18D is a graph of an example waveform associated with the 0.5 mm lead break test conducted at the outer edge of the thickness of the plate of FIG. 18A-C, as detected by a 300 kHz sensor placed at the 150 mm distance from an edge of the plate;

FIG. 19 is a schematic representation of a plate with a centrally disposed microcrack and an example array of sensors S₁₋₆ arranged as shown;

FIG. 20A is a graph showing example acoustic energy waveforms associated with a microcrack at a neutral axis of the plate of FIG. 19, as detected by sensor S₁ of FIG. 19, positioned at a 90-degree orientation and 100 mm radial distance from the microcrack;

FIG. 20B is a graph showing example acoustic energy waveforms associated with a microcrack a microcrack near a top surface of the plate of FIG. 19, as detected by sensor S₁ of FIG. 19, positioned at a 90-degree orientation and 100 mm radial distance from the microcrack;

FIG. 20C is a graph showing example acoustic energy waveforms associated with a microcrack at a neutral axis of the plate of FIG. 19, as detected by sensor S₃ of FIG. 19, positioned at a 63-degree orientation and 100 mm radial distance from the microcrack;

FIG. 20D is a graph showing example acoustic energy waveforms associated with a microcrack a microcrack near a top surface of the plate of FIG. 19, as detected by sensor S₃ of FIG. 19, positioned at a 63-degree orientation and 100 mm radial distance from the microcrack;

FIG. 20E is a graph showing example acoustic energy waveforms associated with a microcrack at a neutral axis of the plate of FIG. 19, as detected by sensor S₅ of FIG. 19, positioned at a 45-degree orientation and 100 mm radial distance from the microcrack;

FIG. 20F is a graph showing example acoustic energy waveforms associated with a microcrack a microcrack near a top surface of the plate of FIG. 19, as detected by sensor S₅ of FIG. 19, positioned at a 45-degree orientation and 100 mm radial distance from the microcrack;

FIG. 21A is a graph showing example acoustic energy waveforms associated with a microcrack at a neutral axis of the plate of FIG. 19, as detected by sensor S₂ of FIG. 19, positioned at a 90-degree orientation and 200 mm radial distance from the microcrack;

FIG. 21B is a graph showing example acoustic energy waveforms associated with a microcrack a microcrack near a top surface of the plate of FIG. 19, as detected by sensor S₂ of FIG. 19, positioned at a 90-degree orientation and 200 mm radial distance from the microcrack;

FIG. 21C is a graph showing example acoustic energy waveforms associated with a microcrack at a neutral axis of the plate of FIG. 19, as detected by sensor S₄ of FIG. 19, positioned at a 63-degree orientation and 200 mm radial distance from the microcrack;

FIG. 21D is a graph showing example acoustic energy waveforms associated with a microcrack a microcrack near a top surface of the plate of FIG. 19, as detected by sensor S₄ of FIG. 19, positioned at a 63-degree orientation and 200 mm radial distance from the microcrack;

FIG. 21E is a graph showing example acoustic energy waveforms associated with a microcrack at a neutral axis of the plate of FIG. 19, as detected by sensor S₆ of FIG. 19, positioned at a 45-degree orientation and 200 mm radial distance from the microcrack;

FIG. 21F is a graph showing example acoustic energy waveforms associated with a microcrack a microcrack near a top surface of the plate of FIG. 19, as detected by sensor S₆ of FIG. 19, positioned at a 45-degree orientation and 200 mm radial distance from the microcrack;

FIG. 22A is a graph of an example shear horizontal wave form associated with a tip of the microcrack in the plate of FIG. 19, as detected by sensor S₃ of FIG. 19, positioned at a 63-degree orientation and 100 mm radial distance from the microcrack;

FIG. 22B is a graph of an example shear horizontal wave form associated with a tip of the microcrack in the plate of FIG. 19, as detected by sensor S₄ of FIG. 19, positioned at a 63-degree orientation and 200 mm radial distance from the microcrack;

FIG. 22C is a graph of an example shear horizontal wave form associated with a tip of the microcrack in the plate of FIG. 19, as detected by sensor S₅ of FIG. 19, positioned at a 45-degree orientation and 100 mm radial distance from the microcrack;

FIG. 22D is a graph of an example shear horizontal wave form associated with a tip of the microcrack in the plate of FIG. 19, as detected by sensor S₆ of FIG. 19, positioned at a 45-degree orientation and 200 mm radial distance from the microcrack; and

FIG. 23 illustrates example elements of an example computing device.

### DETAILED DESCRIPTION

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

In this document, when terms such as “first” and “second” are used to modify a noun, such use is simply intended to distinguish one item from another and is not intended to require a sequential order unless specifically stated. In addition, terms of relative position such as “vertical” and “horizontal”, or “front” and “rear”, when used, are intended to be relative to each other and need not be absolute and only refer to one possible position of the device associated with those terms depending on the device's orientation.

Devices, systems, and methods of the present disclosure may be understood more readily by reference to the following detailed description of the embodiments taken in connection with the accompanying drawing figures, which form a part of this disclosure. It is to be understood that this application is not limited to the specific devices, systems, methods, conditions or parameters described and/or shown herein, and that the terminology used herein is for the purpose of describing particular embodiments by way of example only and is not intended to be limiting. Reference to a particular numerical value includes at least that particular value, unless the context clearly dictates otherwise.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other and are not necessarily “superior” and “inferior”. The words “can” or “may” are used to communicate that this is one embodiment, but others are contemplated.

In general, those of ordinary skill in the art will understand unless otherwise noted that a number or range contemplates the inclusion of +/−10%.

Various examples of the disclosed technology are provided throughout this disclosure. The use of these examples is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification and can be made without departing from its spirit and scope. The invention is therefore to be limited only by the terms of the claims, along with the full scope of equivalents to which the claims are entitled.\

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

Acoustic emission transducer calibration procedures can relate characteristics and a magnitude of acoustic sources with measured acoustic emission (“AE”) waveform parameters. A resulting relationship can form a basis of interpreting results in practical applications. In some embodiments, idealized conditions, such as a large calibration block to relate the source input with the measured signal parameters, can be used to minimize an influence of propagation.

In alternative embodiments, AE signals can be interpreted that propagate in thin members, such as beams or plates, whose geometry dominate detected signal characteristics. For example, geometry can dominate detected signal characteristics when larger displacements are generated by a fundamental antisymmetric mode (“A₀”) of a Lamb wave when compared to a first symmetric mode (“S₀”) of the Lamb wave. From the detected waveforms several acoustic emission parameters can be derived to characterize the received signal and a microcracks or a crack extension, which produced the waveforms, can be quantified. Said AE parameters can include amplitude, counts, count rate, energy, risetime, duration, and average frequency. The parameters associated with individual AE events can form the basis of estimating the rate of crack growth and facilitate further analysis of the integrity of the structure.

Many acoustic emission signals can be collected from each of the specimens and many of the acoustic emission signals can be generated by one or more incremental crack growth steps at a microscopic level. The energy released by each of the incremental crack growth steps can be uniquely related to the AE parameter, such as AE energy or count rate. During AE monitoring of fatigue crack growth, variation in AE amplitudes can be detected, even during periods when crack growth rates are constant. For example, in thin beams or plates, more than an order of magnitude of variation in AE amplitudes can be observed. AE energy can also vary. For example, AE energy variation can exceed two orders of magnitude. Acoustic emission levels from such specimens can be governed by microstructural variables associated with deformation and fracture process. In some embodiments, variations in amplitudes may not be due to the differences in source mechanisms and their emissivity.

A relationship between the source strength and the resulting acoustic emission parameters can differ in thin structures, such as beams and plates, as compared to three dimensional bodies. Estimating crack growth rates can be useful in structural monitoring. AE energy can be a suitable parameter for estimating the crack growth rate. In some embodiments, the sources that generate the symmetric and antisymmetric components of AE signals in structural elements and the influence of the source location across a thickness of a waveguide on the magnitude of the acoustic emission energy can be quantified. The presence of the A₀ mode in AE signals can distort the relationship between the AE event's energy and the magnitude of its source. The relationship between the location of the source and the resulting AE energy can be used to determine a reliable estimate of crack growth rate based on the AE technique. In some embodiments, the present invention establishes procedures to relate a source event and the resulting AE parameters in common test specimen geometries, such as tensile coupons, which may be modeled as beams. In some embodiments, a relationship is established between an extent of an interior crack growth and a resulting AE waveform.

Embodiments of the present invention relate to systems and methods for determining acoustic emission (“AE”) energy that reliably correlates with crack growth rate. A relationship between energy in an AE signal and a magnitude of its source can be used for estimating the crack growth rate to monitor health of structural components. For example, in beams and plates, the relationship can vary depending on a location of a source event relative to a neutral axis of the structural component. In some embodiments, an influence of symmetric modes and antisymmetric modes in the AE signal energy and quantification of a source magnitude can be addressed.

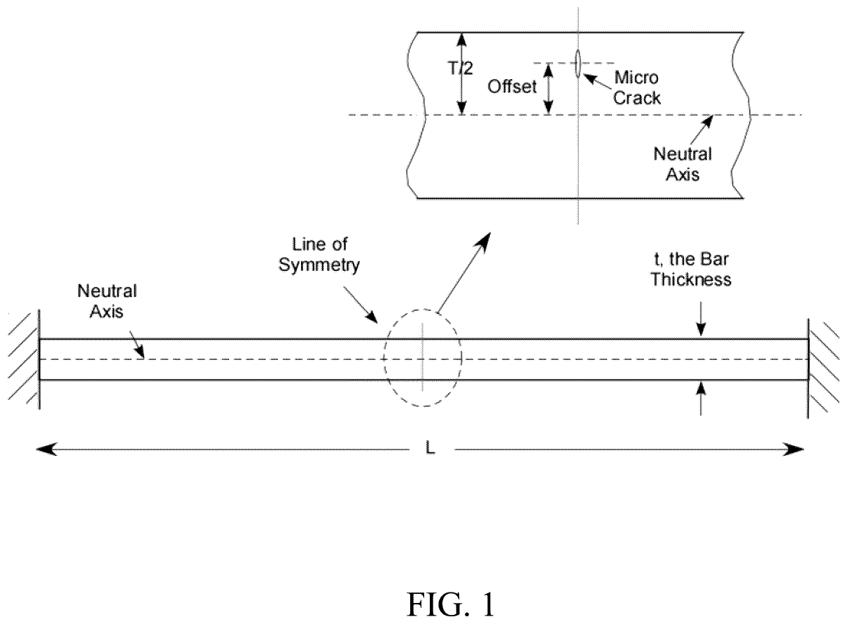

Propagation of AE signals from ideal acoustic sources in the structural components can be numerically simulated, and signals from point sensors can be further considered. For example, several locations of acoustic sources relative to the neutral axis of a beam can be considered. Referring to FIG. 1, ideal displacement and ideal strain due to AE waves can be determined along a length of the beam. AE energy obtained from displacement waveforms can vary from a change in position of the acoustic source. In some embodiments, the AE energy obtained from displacement waveforms can vary by as much as three orders of magnitude. AE energy obtained from strain waveforms can also vary from a change in position of the acoustic source. In some embodiments, the strain waveforms can vary by a single order of magnitude due to change in source position. In some embodiments, the strain waveforms can have a symmetric mode that is larger when compared to the symmetric mode of the displacement waveforms.

In some embodiments, acoustic emission indications may not be representative of the underlying crack growth rate for a surface crack growing through a thickness of the beam. In some embodiments, sensor selection and considering only the initial symmetric component of the waveforms at a sufficient distance from the source can minimize influence of the antisymmetric mode. In other embodiments, the AE signals can be modified by several factors including a frequency content and/or an emissivity of AE sources as well as frequency response characteristics of sensors used.

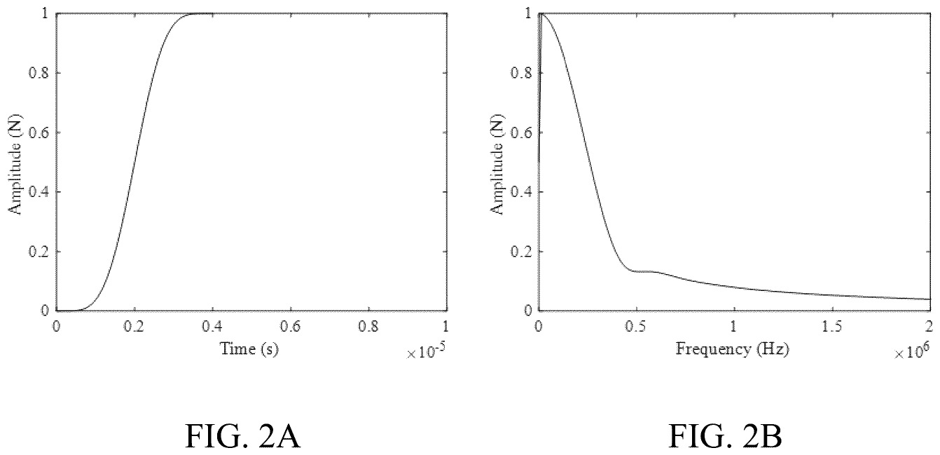

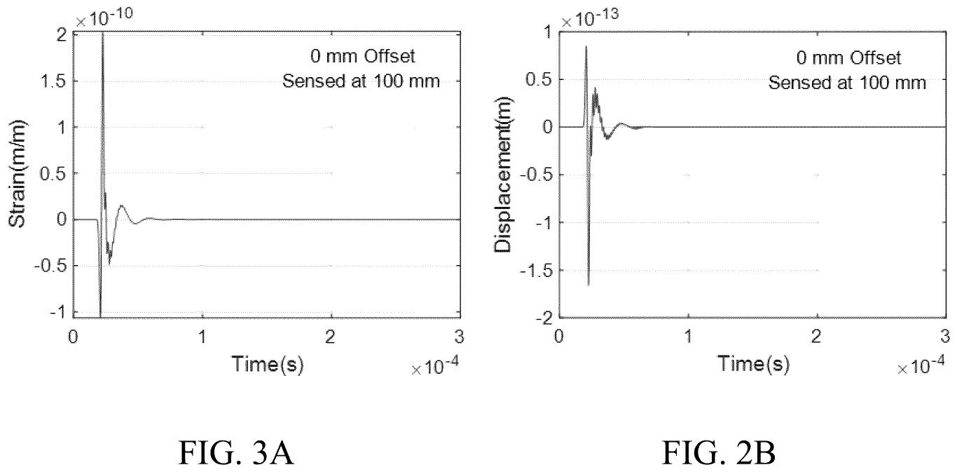

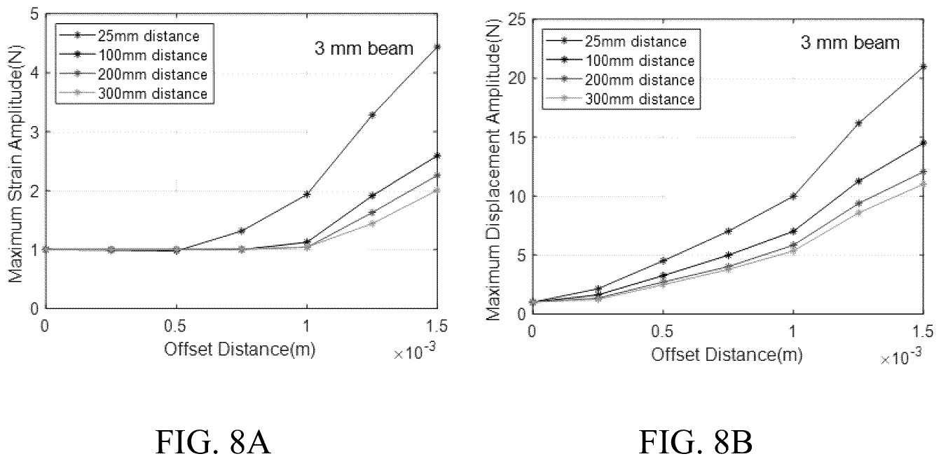

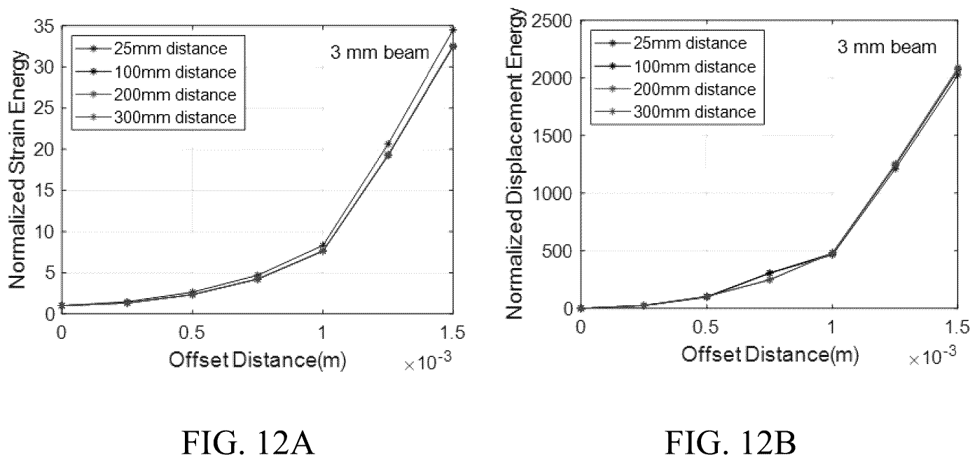

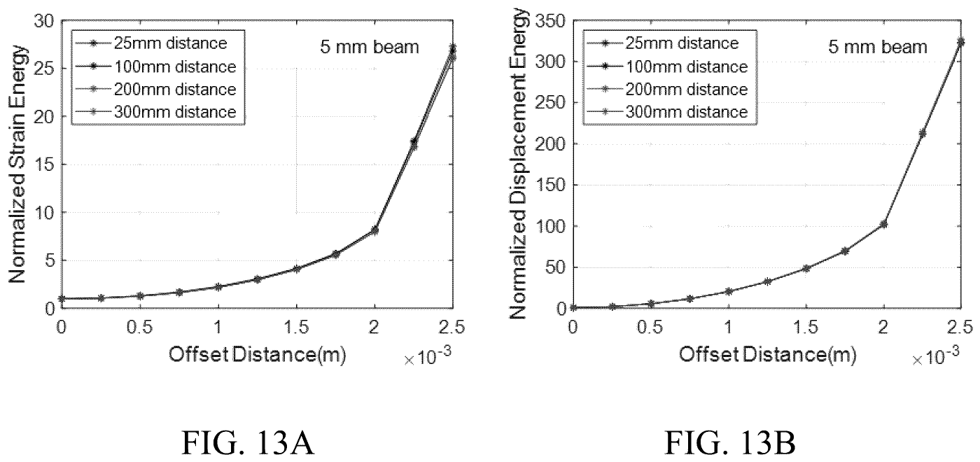

FIGS. 2A-22D demonstrate testing conducted under certain limited conditions, such as with defined structures (e.g., a beam or a plate). However, those of ordinary skill in the art will understand that embodiments of the invention and applications of the technology are not limited to such conditions and structures. There are also implicitly understood aspects of the invention.

Referring to the figures, an influence of a microcrack location relative to the neutral axis on AE energy and amplitudes can be demonstrated by simulations and/or testing. For example, a finite element model in which a force dipole is used to represent the release of AE into the beam when a small crack forms can be used. Several locations of the dipole sources relative to the neutral axis can be considered. Resulting AE signals can be characterized in terms of conventional AE parameters. Signals detected by conventional acoustic emission sensors can be related to the displacements normal to the beam surfaces. Waveforms corresponding to normal displacements and surface strains can be determined for different locations of microcracks relative to a midplane

In some embodiments, signals can also be detected by fiber optic acoustic emission sensors or strips of bonded piezoelectric wafers that are related to surface strains in the direction of wave propagation. Fiber optic AE sensors can reproduce high fidelity signals resembling surface strains. In some embodiments, only ideal waveforms are considered. In alternative embodiments, nonideal waveforms can be considered. For example, the sensors can modify the waveforms according to their frequency response characteristics.

The normal displacements and strains at different sensor positions on the beam surface can be sensed signals. Idealized displacements and strains can be determined at a point. In some embodiments, a load versus time of the dipole impulse can be selected such that the signal primarily consists of the fundamental symmetric and the antisymmetric modes with a frequency cutoff threshold. For example, the load versus time of the dipole impulse can be selected such that the signal primarily consists of the fundamental symmetric and the antisymmetric modes with a frequency the content extending to about 500 kHz. The energy in acoustic emission signal can be compared to the energy input by the AE source. Calculations can be performed for several sensing locations corresponding to each of the AE sources at various locations along the thickness of the beam. In some embodiments, calculations can be performed for several sensing locations corresponding to each of the AE sources at various locations along the thickness of the beam after filtering the waveforms. For example, a 100 kHz high pass filter can be used to filter the waveforms.

Referring to FIG. 1, example analyses can be performed for an aluminum beam of thicknesses 2 mm, 3 mm, and 5 mm. A density, an elastic modulus, and a Poisson's ratio for the material can be approximately 2710 kg/m3, 73 GPa, and 0.33, respectively. While aluminum is referenced in this example, embodiments of the systems of the present invention are capable of detecting and monitoring cracks in a wide range of materials, such as concrete, metal, composite, etc. A finite element code can be used to obtain the AE signals excited by source events. In some embodiments, a time step associated with numerical integration and element sizes used can be suitable for accurately modeling the frequency components of interest. As shown in FIG. 1, a 2-meter-long beam with AE sources at the center, can represent a model to be studied. Each model can consider the microcrack to be located at a different offset distance from the neutral axis. Using symmetry, a right half of the beam with fixed boundary condition can be modeled. Signals corresponding to normal displacements and axial strains on the top surface of the beam at source to sensor distances of 25 mm to 300 mm, at 25 mm intervals, can be determined. In some embodiments, the signals can travel along the beam length without attenuation. In some embodiments, results from many simulations can be analyzed to generate results. In some embodiments, the formation of the microcrack can be simulated by an impulse applied at the center of the microcrack.

Referring to FIGS. 2A and 2B, a pulse used in simulations can be an integrated sinusoidal pulse with a rise time of 4e-6 seconds and an amplitude of 1 Newton (N). In some embodiments, a moment tensor component can be calculated using a source function given by.

$$dS ( t ) / dt = {sin}^{4} ( \frac{π t}{Tr} ) ,$$

(0<t<Tr) with the rise time set to 2 μs. Detected waveform from crack events can present similarities with a synthetic waveform induced by a source-time function. The pulse can generate the fundamental symmetric (S₀) and antisymmetric (A₀) Lamb wave in the beams to be studied.

Referring to FIGS. 3A to 6B acoustic emission waveforms corresponding to different source locations along the thickness direction in 3 mm thick beams is shown. For each of the AE sources, signals received at source to sensor distances from 25 mm to 300 mm can be determined. The figures show plots for 100 mm and 300 mm source to sensor distances. The axial strains and normal displacements at the sensing locations are shown for each case. In some embodiments, as the AE source is moved from the neutral axis towards the surface, the amplitude of A₀ mode increases.

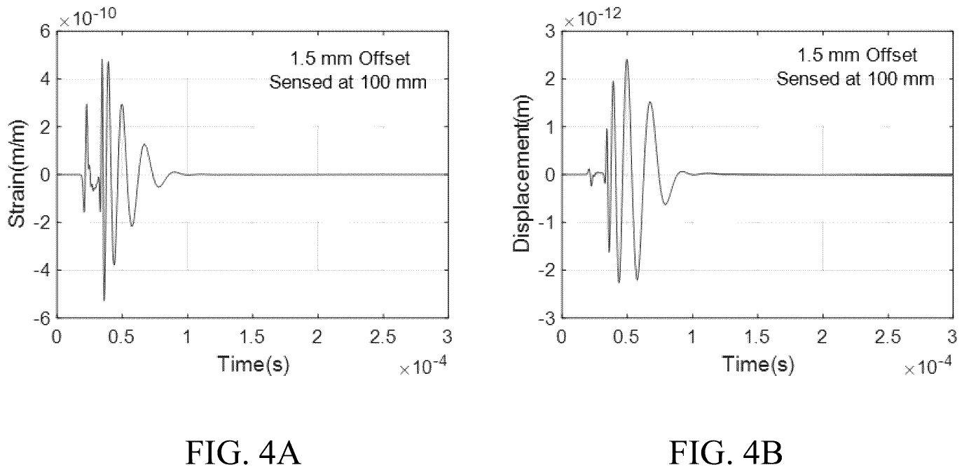

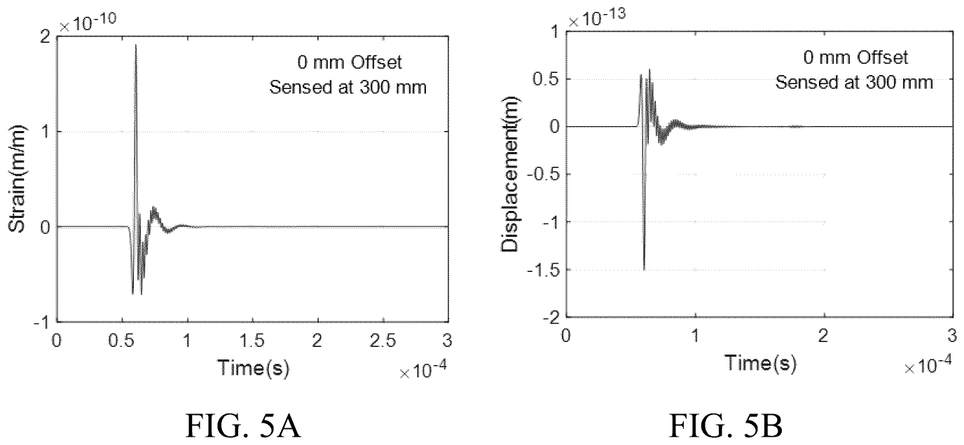

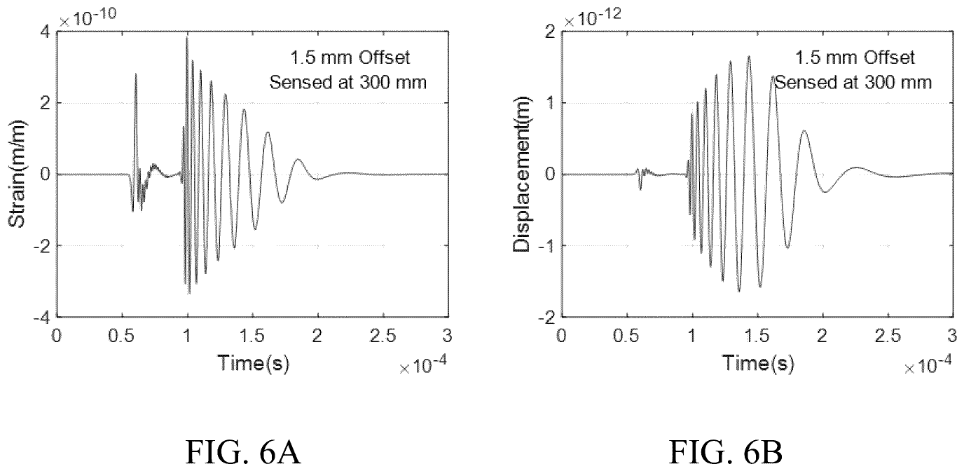

Referring to FIGS. 3A-4B, the signals corresponding to AE source at the neutral axis can be compared with the signals of another source close to the surface of the beam. The AE waveforms that are associated with the surface strain are shown in FIG. 3A and waveforms that are based on normal displacement are shown in FIG. 3B. As shown in FIG. 3A, waveforms that are based on surface strain, a microcrack located at the surface of the beam can generate an AE amplitude that is greater than a similar crack located at the neutral axis. For example, the microcrack located at the surface of the beam can generate an AE amplitude associated with surface strain that is nearly three times that of the of microcrack located at the neutral axis. In some embodiments, the duration can be nearly doubled. As shown in FIG. 3B, the normal displacement waveforms can also experience variation at similar locations. For example, the microcrack located at the surface of the beam can generate an AE amplitude associated with normal displacement that is nearly ten times that of the of microcrack located at the neutral axis. In some embodiments. the increases in the amplitudes can be due to the introduction of the fundamental antisymmetric mode. Referring to FIGS. 5A-6B, a similar comparison can be made for signals detected at a location 300 mm away from the sources.

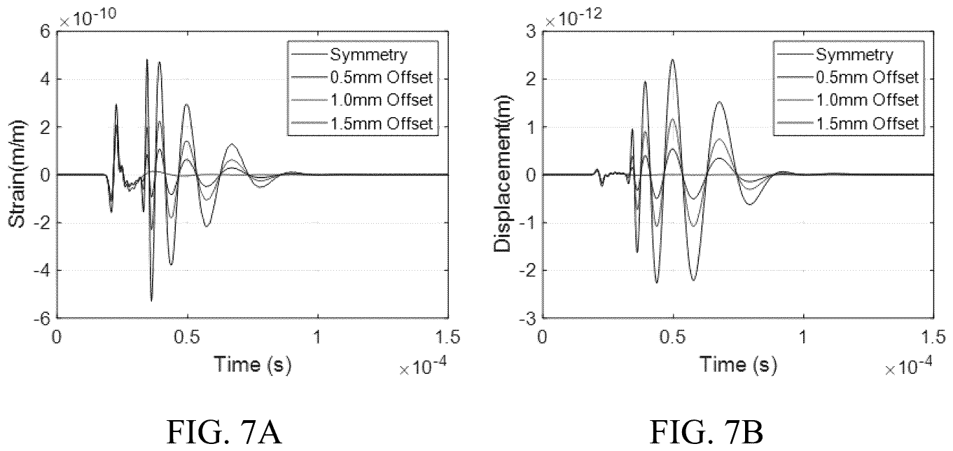

The magnitude by which the overall AE signal changes are recognized can be important to interpret AE signals related to a degree of damage growth. Referring to FIGS. 7A and 7B, superposition of AE waveforms can be obtained for acoustic sources distributed across the thickness of the 3 mm beam at a source to sensor distance of 100 mm. The symmetric component of the waveform can remain the same for acoustic sources irrespective of their position relative to the neutral axis. The antisymmetric component, however, can significantly vary with the position of acoustic sources relative to the neutral axis. In some embodiments. the influence of antisymmetric mode is less pronounced for AE waveforms associated with axial strain. In some embodiments, the symmetric component of the AE waveform associated with axial strain can have sufficient amplitude relative to the antisymmetric component for all cases.

The amplitudes of acoustic emission signals can be influenced by an offset distance of the AE source in relation to the neutral axis. Referring to FOGS. 8A-8B, a variation of the maximum amplitude of the AE signal versus the offset distance for a 3 mm thick beam can be observed. The variation of the AE amplitude as a function of the offset distance of the AE source can be plotted for signals detected at various positions along the length of the beam. These amplitudes are normalized with the amplitude of waveform of the source at the neutral axis. In some embodiments, an increase in amplitude is a function of an increase in offset distance of the AE source, for signals at each axial location of the beam. In some embodiments, as the AE signal travels along the length of the beam, due to dispersion, the amplitude decreases.

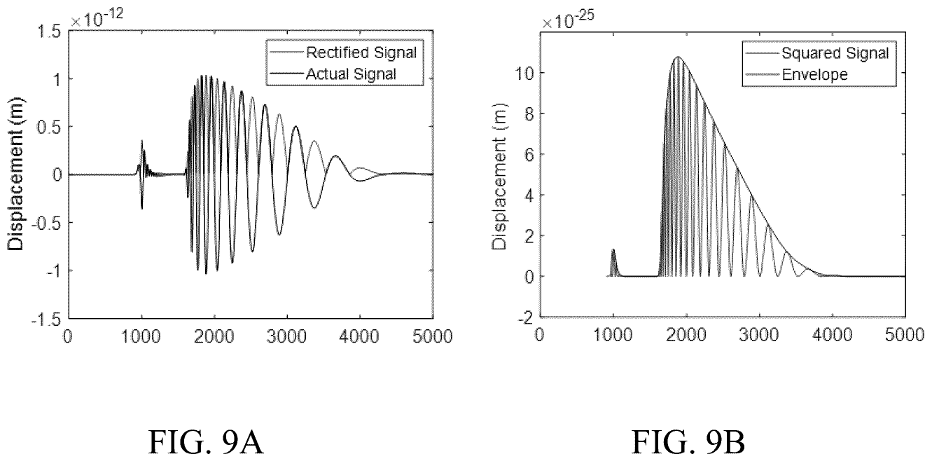

Referring to FIGS. 9A-9B, the energy in the acoustic emission signal can be determined using analytical techniques. For example, as shown in FIG. 9A, the waveform can be rectified. Then, as shown in FIG. 9B, the waveform can be squared and an envelope fitted over the squared signal. In some embodiments, an area under the envelope can be the energy of the AE signal.

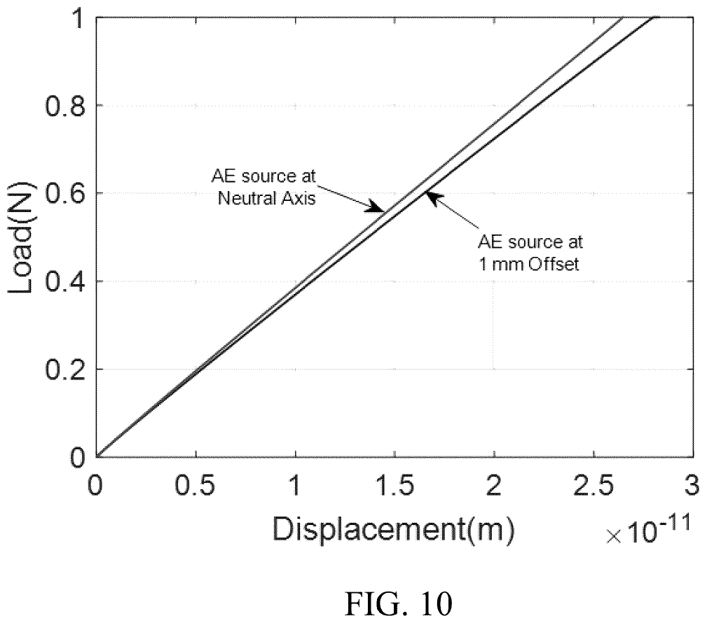

Referring to FIG. 10, the force versus displacement variation for the impulses used to simulate acoustic emission events in 3 mm beams can be plotted for two positions of the source event. In some embodiments, the energy of the simulated AE sources can be represented by an area under the force versus displacement curves. In some embodiments, the energy input from a unit impulse can vary with the offset distance from the neutral axis, which can be included in the determination of sensed AE energy for unit source energy. In some embodiments, actual input energy values can be used to normalize the detected AE energies.

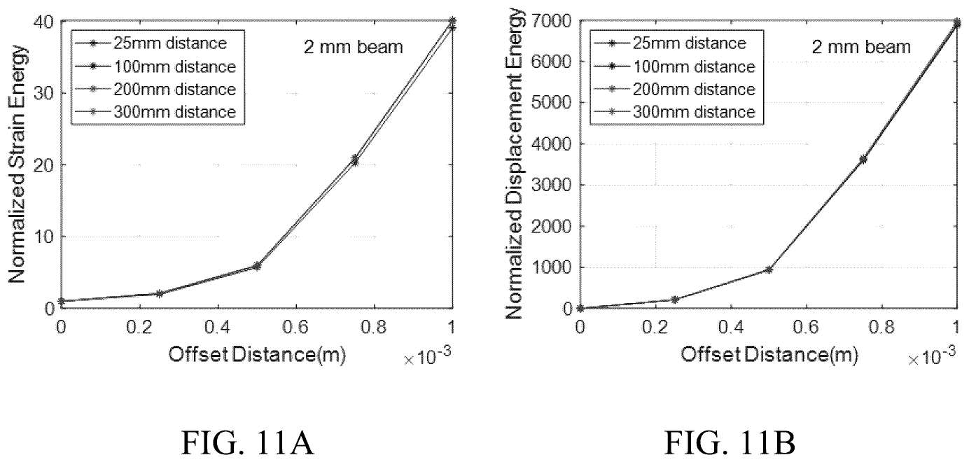

Referring to FIGS. 11A-13B, variation of the energy of sensed AE waveforms with the offset of acoustic source from neutral axis for beam thicknesses of 2 mm, 3 mm, and 5 mm, can be observed. The figures include values for energies sensed at different source to sensor distances. In some embodiments, sensed AE energies for the source locations can be normalized by dividing the sensed AE energy by the energy of the source at the neutral axis. The figures demonstrate several aspects of the influence of source location along the beam thickness direction on the detected AE energy. In embodiments using idealized AE waveforms, a shift of the AE source away from the neutral axis can change in the magnitude of AE energy. In some embodiments, the changes can be reduced as the beam thickness increases. In some embodiments, when AE energy is determined from axial strain measured on the beam surface, the energy of the AE source near the top surface of the beam, such as for the 3 mm beam, can be greater than the energy of the AE source located at the neutral axis of the same beam. For example, the energy of the AE source near the top surface of the beam can be approximately 30 times the energy of the AE source located at the neutral axis of the same beam. In embodiments, where the AE energy is determined from beam normal displacement measured on the beam surface can be greater than the energy of the AE source located at the neutral axis of the same beam. For example, the energy of the AE source near the top surface of the beam can be approximately 7000 times that of the AE source located at the neutral axis of the beam. In some embodiments, in the absence of attenuation, the sensed AE energy can be independent of source to sensor distance.

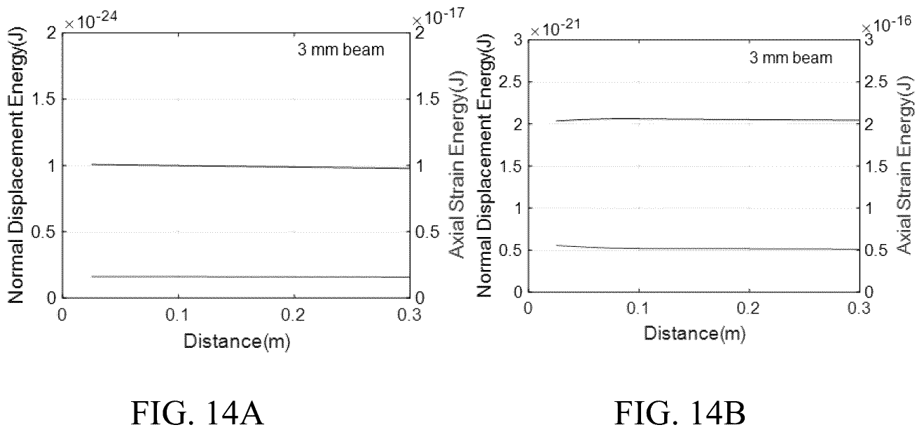

Referring to FIG. 14A-B, the variation of the sensed AE energy at different locations along the length of the 3 mm beam can be observed. Signals corresponding to displacements normal to the beam surface are shown as blue lines. Signals due to the axial strain are shown as red lines. FIG. 14A depicts simulated AE sources located at the neutral axis of the beam. FIG. 14B shows AE sources located at the top surface of the beam. In some embodiments, as the AE source of unit force magnitude moves away from the neutral axis to the beam surface, the resulting displacement increases, causing the energy of the AE source to increase.

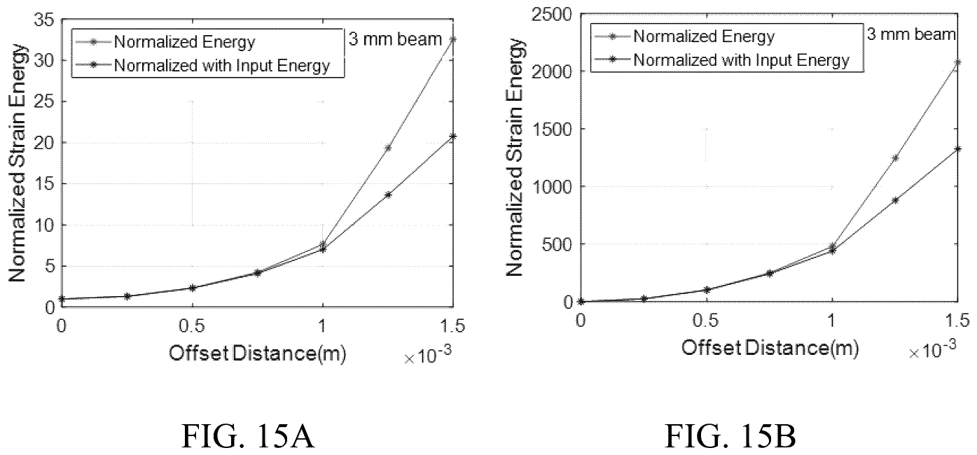

Referring to FIGS. 15A and 15B, the detected acoustic emission energy can be normalized with the AE source energy to observe the influence of a change in energy AE source. FIGS. 15A-B show the detected acoustic emission energy can be normalized with the AE source energy plotted in for the sensor location at 200 mm for the 3 mm beam. FIGS. 15A and 15B also show the variation of sensed energy without the normalization with input acoustic energy. In some embodiments, the differences are minor relative to the overall variations.

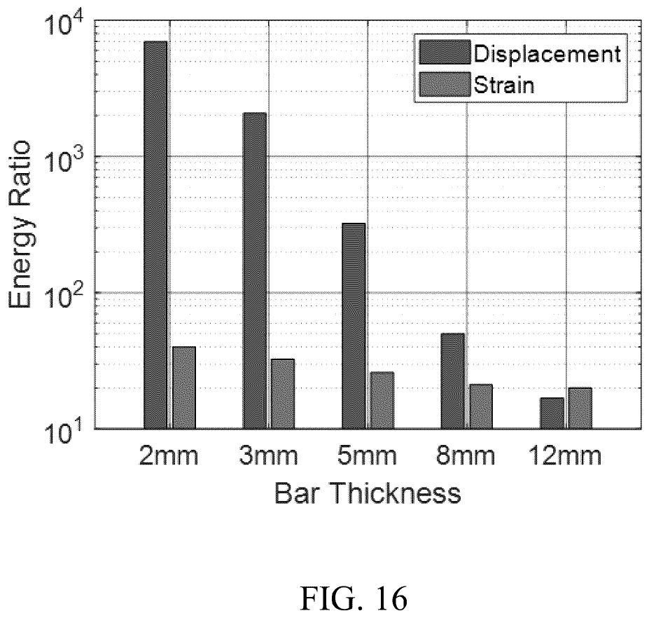

Referring to FIG. 16, the influence of the AE source offset from the neutral axis on the measured AE energy for beams of different thicknesses can be observed. The ratio of energy for a source at the beam surface relative to the same source at the neutral axis is shown in FIG. 16 for different beam thicknesses. The blue bars indicate the ratios of normal displacement based energy. The red bars indicate the ratios of axial strain based energy. In some embodiments, as the beam thickness decreases, the value of these ratios of normal displacement based energy and axial strain based energy decrease. In addition, for most cases considered, the ratios from axial strain signal are substantially smaller than those from normal displacements.

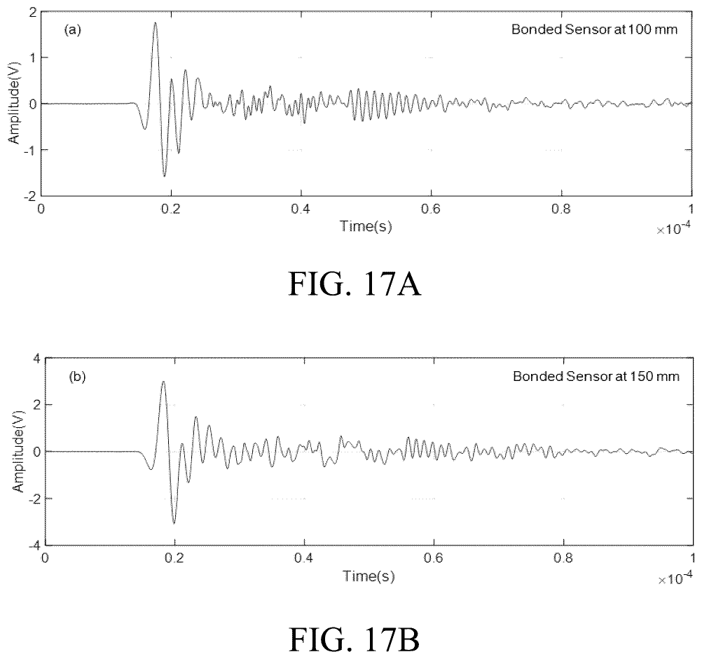

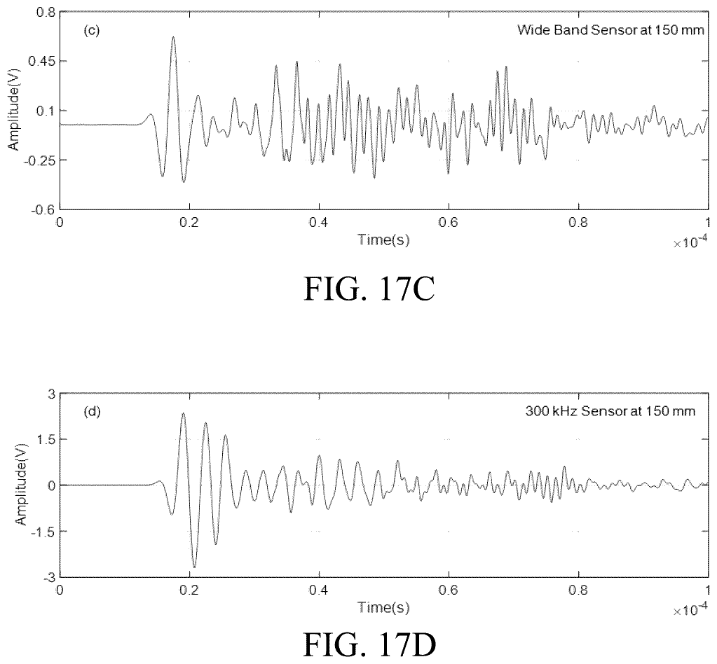

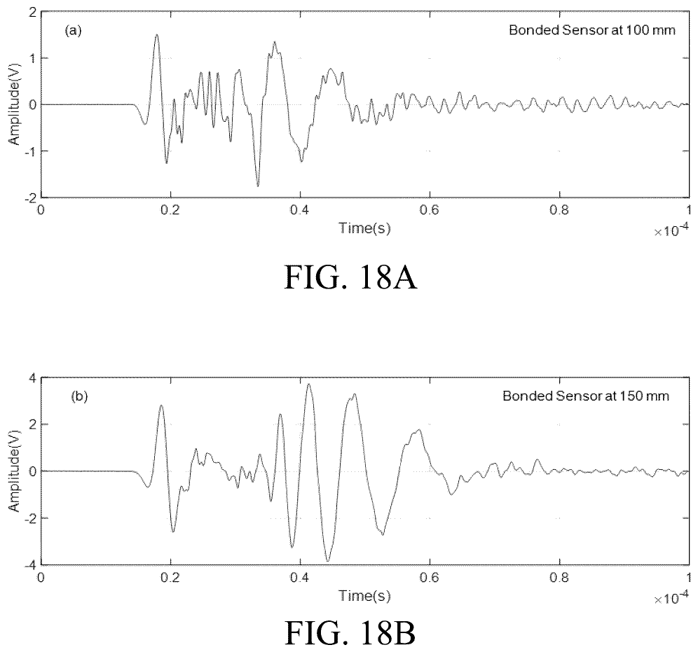

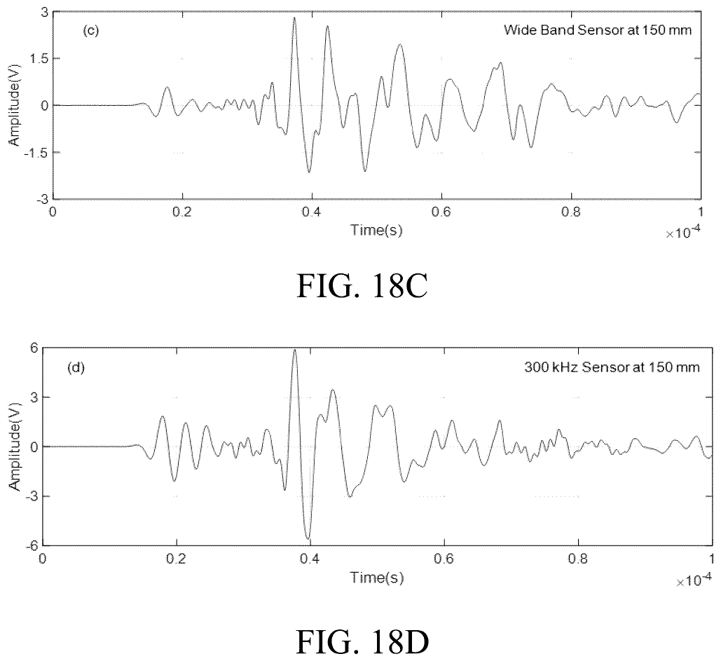

Referring to FIGS. 17A-18D, empirical studies can be used to verify numerical simulations. For example, the results of the numerical simulations can be verified with pencil lead break tests performed on a 3 mm×600 mm×600 mm aluminum plate. Sensors can be used to detect the signals generated by pencil lead breaks. For example, two sensors fabricated from 20 mm×10 mm lead zirconate titanate (“PZT”) 5A wafers with a 1 mm sensing electrode and bonded at distances of 100 mm and 150 mm from the edge of the plate can be used to detect the signals generated by the pencil lead breaks. In some embodiments, a commercially available 300 kHz resonant frequency sensor and a commercially available wide band sensor with sensitivity to 1 MHz can be used to detect the waveforms.

Referring to FIGS. 17A-E, a comparison of waveforms the sensors generated in response to a 0.5 mm pencil lead break approximately at the center of the plate thickness can be observed. The waveforms from the bonded sensors both show the S₀ component of the guided wave, along with small amplitudes of other modal components. In some embodiments, although the S₀ component is present with 300 kHz sensor and the wide band sensor the, the sensors can be more sensitive to signal components that arrive after the S₀ component.

Referring to FIGS. 18A-18E, a comparison of waveforms the four sensors generated in response to a 0.5 mm pencil lead break approximately at an edge of the plate thickness. As shown in FIGS. 18A and 18B, both the S₀ and A₀ components are detected by the bonded sensor. In some embodiments, the amplitudes of the two components can be similar in these waveforms. In other embodiments using the 300 kHz and wideband sensors, the A₀ component is larger than the S₀ component.

The relationship between the magnitude of an acoustic source (e.g. microcrack formation) and the resulting AE waveforms using numerical simulation is described, by way of example, in the figures. The waveforms considered are those due to (i) normal displacements and (b) axial strain, both at the specimen surface at distant locations. Sources of the same magnitude can generate different responses depending on their position relative to the neutral axis. The effect of the antisymmetric mode on measured acoustic emission parameters such as amplitude and energy can be determined from the results of numerical simulation. In some embodiments, there are differences between the AE waveforms corresponding to displacement and strain. In some embodiments, the antisymmetric mode can be overrepresented in the displacement-based waveforms compared to the strain-based waveforms. In some embodiments, larger variations in the AE amplitude and energy can be present in displacement-based waveforms. In some embodiments, the detected energy in the AE waveform generated by a source at the beam surface is hundreds of times larger than that of a source of the same magnitude located at the center of the beam thickness. A crack starting from the surface and propagating across the thickness can have different AE energy rate versus the rate of crack growth rate during its propagation. In some embodiments, for example with thicker beams, the differences decrease but still remain significant.

The energy of the axial strain based acoustic emission signal is somewhat less affected by the location of the source across the thickness. In the absence of significant attenuation, the energy in AE waveform remains practically same for the different source to sensor distances considered in beams. Since, the acoustic emission energy of the fundamental symmetric mode remains unaffected by the shift of the AE source from the neutral axis, there is a potential to minimize the influence of the antisymmetric mode by confining the AE energy measurement to the initial portion of the AE waveform, detected at sufficient distance from the source for separation of the two modes.

In some embodiments, ideal responses can be affected by factors including the frequency content and emissivity of acoustic emission sources and transducer frequency response characteristics. Said factors can be included when interpreting the results. In some embodiments, the type of sensor and signal processing methods can be varied to achieve a quantitative relationship between damage activity and measured acoustic emission signal parameters, such as amplitude and energy.

In some embodiments, the relationship between AE energy rates and crack growth rates can be unaffected by certain effects, such as the case of a through-the-thickness crack propagating in a plate in an ideally symmetric fashion relative to the neutral axis. In some embodiments, even a minor lack of symmetry in the microstructure or mechanisms during the crack propagation that introduces imbalance in term of acoustic emissivity across the plate thickness can change the AE energy rate versus crack growth rate relationship. In other embodiments, surface flaws and flaws in the interior can be detected and distinguished using the relationship between the overall amplitude of waveforms and the position of the source.

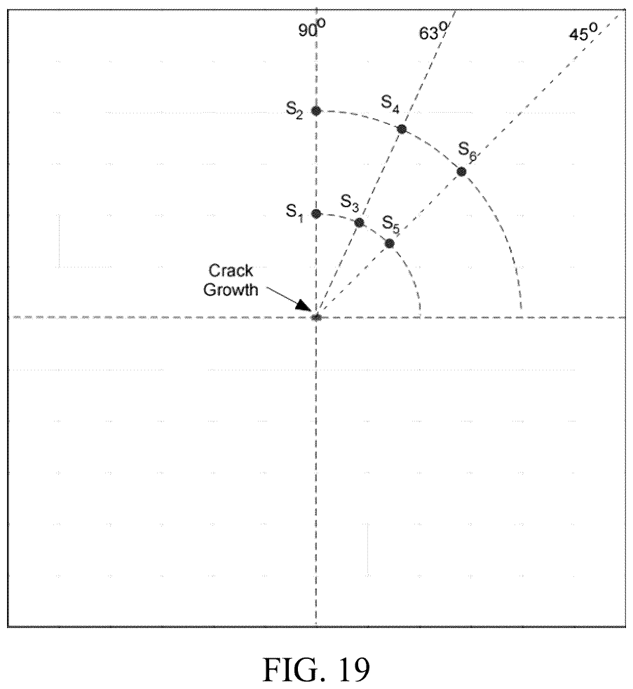

Referring to FIGS. 19-22D, AE signals in plate-like structures can be observed. In some embodiments, for example with beams, only the symmetric and antisymmetric Lamb waves are generated. In addition to symmetric and antisymmetric Lamb waves, crack propagation for plates can generate another type of wave, termed a shear horizontal wave. The figures provide an example of typical waveforms corresponding to different components of the shear horizontal waves.

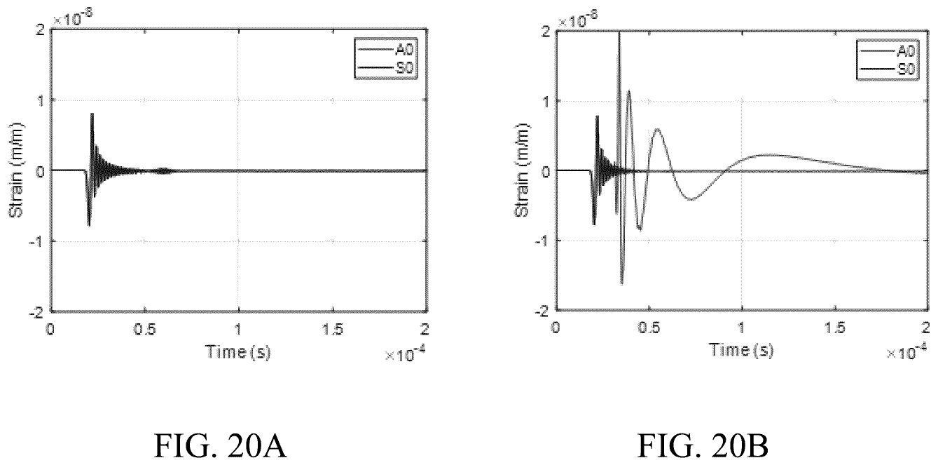

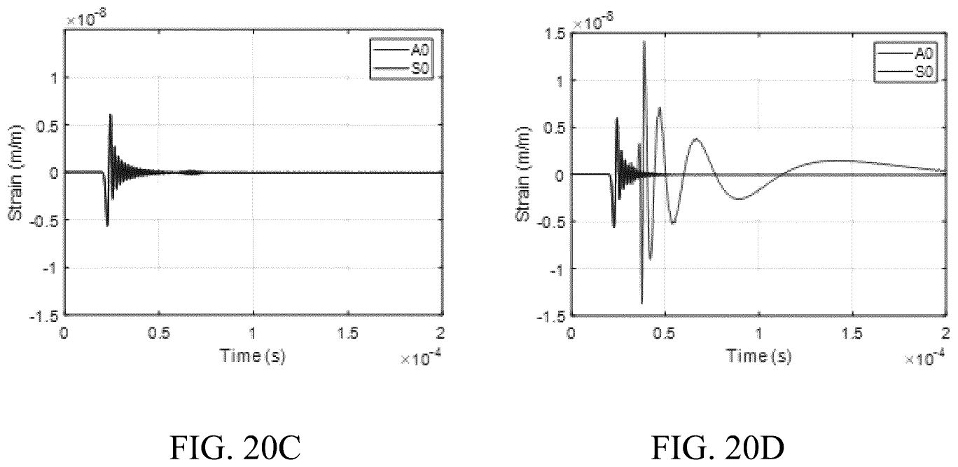

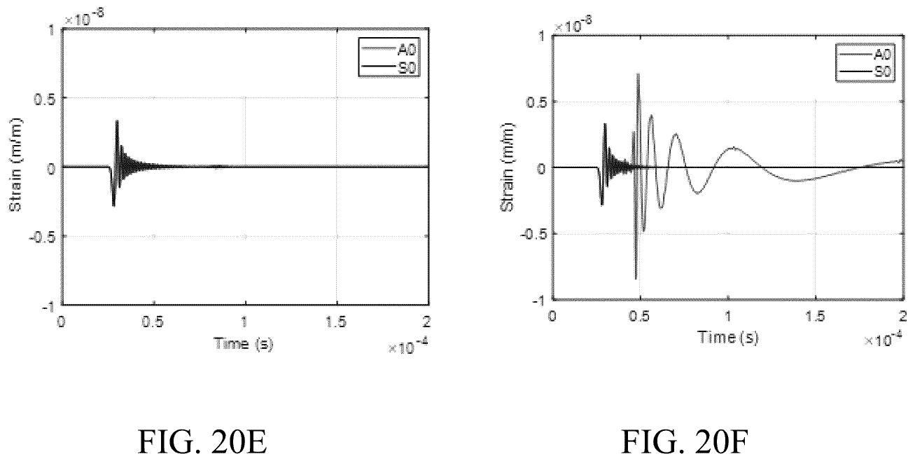

Referring to FIGS. 20A-20F, a comparison of example ideal AE waveforms corresponding to microcracks in plate-like structures can be observed. In the figures, the symmetric portion of the waveform is shown in blue, and the antisymmetric portion of the waveform is shown in red. FIGS. 20A, 20C, and 20E show example AE waveforms associated with a microcrack at neutral axis, sensed at a radial distance of 100 mm from a crack tip and 90-degree, 63-degree, and 45-degree angular positions. FIGS. 20B, 20D, and 20F show example antisymmetric AE waveforms associated with a microcrack near the surface of the plate, sensed at a radial distance of 100 mm from a crack tip and 90-degree, 63-degree, and 45-degree angular positions. In some embodiments, the signals can be detected by bonded piezoelectric wafers, commercial AE sensors, and/or fiber optic sensors.

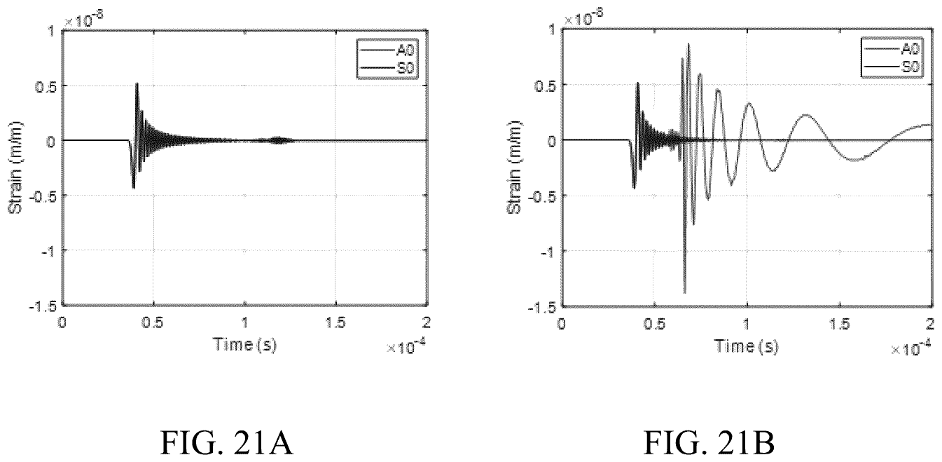

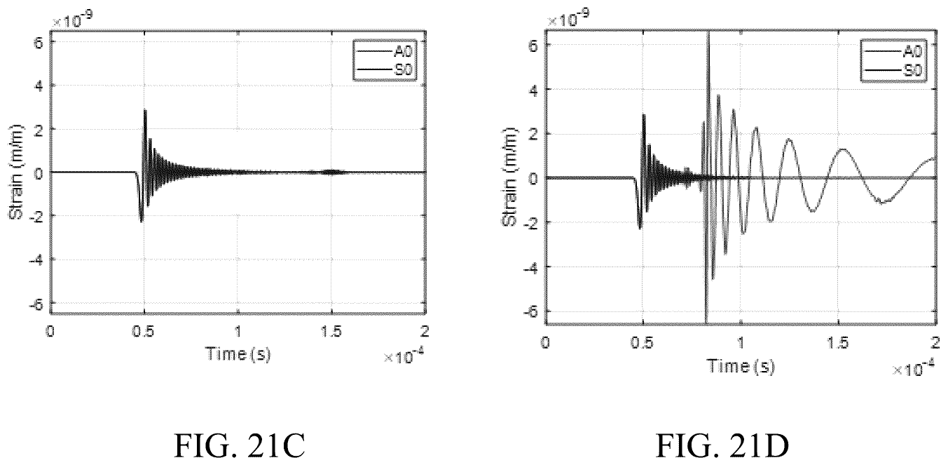

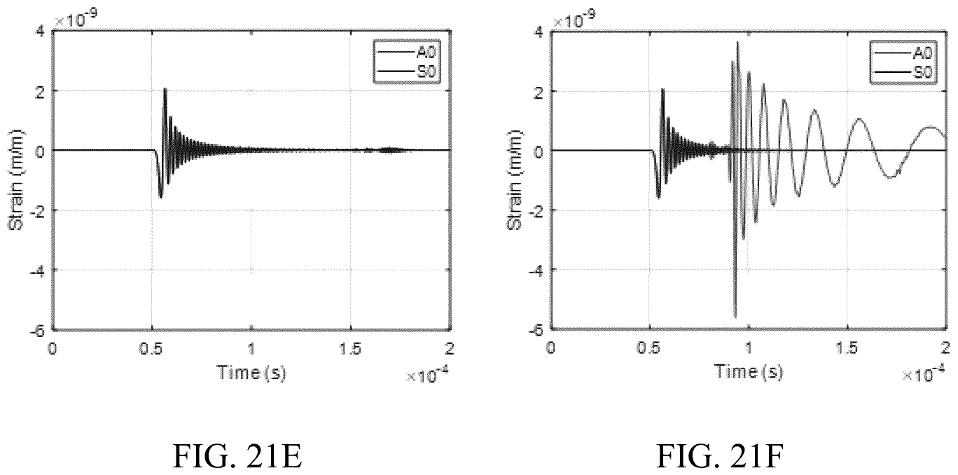

Referring to FIGS. 21A-21F, a comparison of example ideal AE waveforms corresponding to microcracks in plate-like structures can be observed. In the figures, the symmetric portion of the waveform is shown in blue, and the antisymmetric portion of the waveform is shown in red. FIGS. 21A, 21C, and 21E show example AE waveforms associated with a microcrack at neutral axis, sensed at a radial distance of 200 mm from a crack tip and 90-degree, 63-degree, and 45-degree angular positions. FIGS. 21B, 21D, and 21F show example AE waveforms associated with a microcrack near the surface of the plate, sensed at a radial distance of 200 mm from a crack tip and 90-degree, 63-degree, and 45-degree angular positions. In some embodiments, the signals can be detected by bonded piezoelectric wafers, commercial AE sensors, and/or fiber optic sensors.

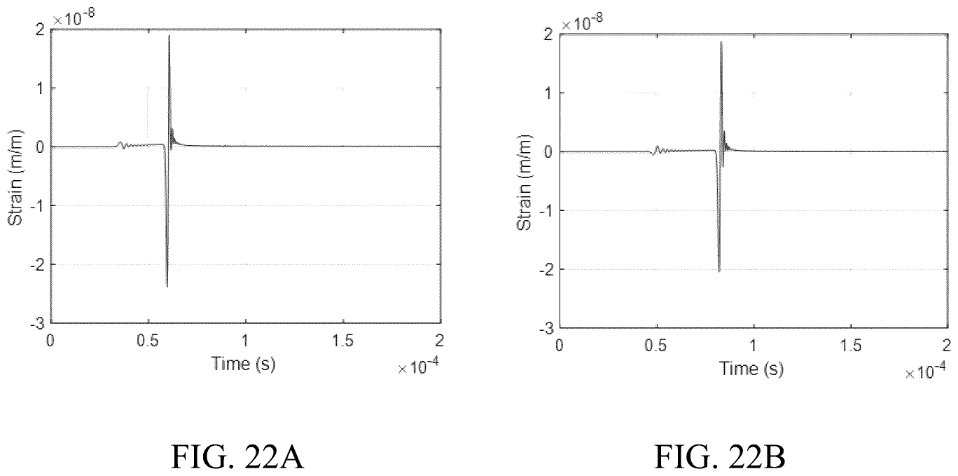

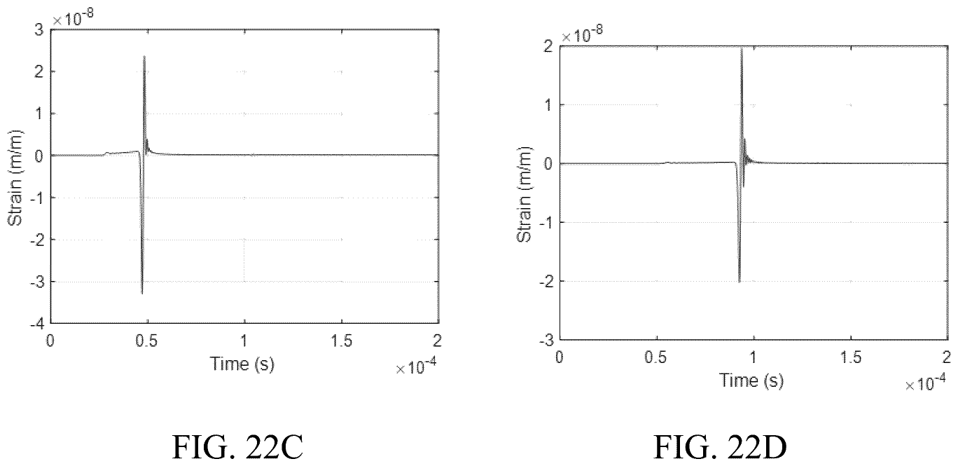

Referring to FIGS. 22A-D, the shear horizontal waveforms at different radial and angular positions around crack tip can be observed. In some embodiments, the shear horizontal component of the guided wave can be independent of the thickness-wise position of the crack extension. In some embodiments, a magnitude of the shear horizontal component is larger than the symmetric mode. In some embodiments, the signals can be detected by bonded piezoelectric sensors poled to detect in-plane shear strains, fiber optic sensors, and/or by specialized AE shear sensors.

The symmetric component of Lamb wave can be detected by bonded piezoelectric wafers, fiber optic sensors, as well as commercial AE sensors. Fiber optic sensors can have increased fidelity when reproducing the signals as compared with commercial AE sensors. The shear horizontal wave can be detected by fiber optic sensors, specialized piezoelectric sensors poled to be sensitive to in-plane shear, and/or AE sensors capable of detecting shear horizontal waves. In some embodiments, the acoustic energy undergoes a change with propagation distance and direction and it is preferable to include the relative position of the sensor from the source (e.g., crack tip) to estimate the rate of crack growth from the AE energy detected by the sensors.

In some embodiments the symmetric component of the Lamb wave can be used to estimate the crack growth rate. In other embodiments, the shear horizontal wave can be used to estimate the crack growth rate. In other embodiments, both the symmetric component of the Lamb wave and the shear horizontal wave can be used to estimate the crack growth rate.

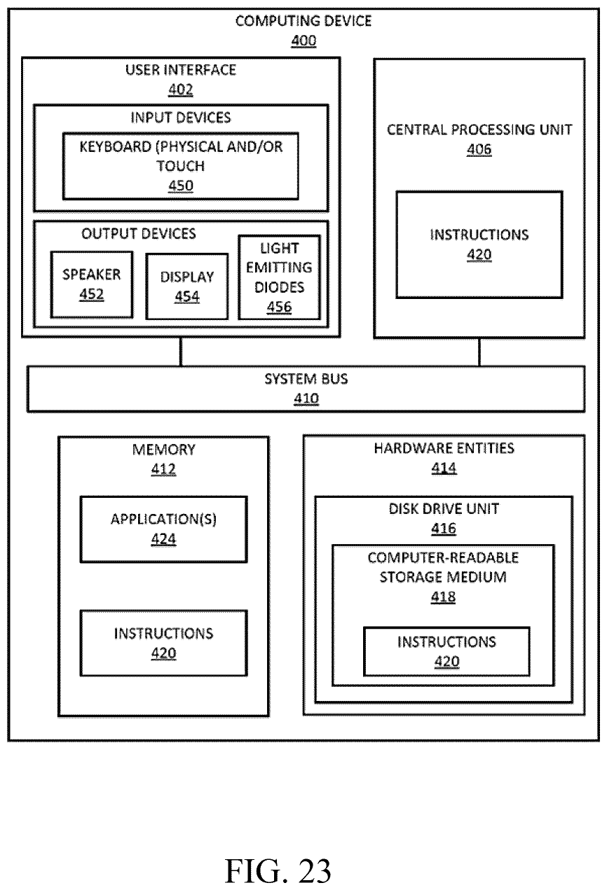

Referring to FIG. 23, an example hardware architecture represents an implementation of a representative computing device configured to perform one or more methods and means for determining acoustic emission energy that reliably correlates with crack growth rate, as described herein. As such, the computing device 400 of FIG. 23 implements at least a portion of the method(s) described herein.

Some or all components of the computing device 400 can be implemented as hardware, software and/or a combination of hardware and software. The hardware includes, but is not limited to, one or more electronic circuits. The electronic circuits can comprise, but are not limited to, passive components (e.g., resistors and capacitors) and/or active components (e.g., amplifiers and/or microprocessors). The passive and/or active components may be adapted to, arranged to and/or programmed to perform one or more of the methodologies, procedures, or functions described herein.

As demonstrated by the foregoing examples, through testing and analysis the inventors have discovered new systems and methods that are capable of detecting crack formation or growth, the rate of growth of microcracks interior to beams, plates, or shells. Embodiments of invention are not limited to such structures. Embodiments of the invention are similarly not limited to the foregoing examples. In general, the inventors found in their testing that the symmetric Lamb wave component of the acoustic emission signal from crack growth has a direct correlation with the rate of crack growth. The research also indicates that the asymmetric Lamb wave should not be used or should substantially be eliminated because it can interfere with the information in the symmetric Lamb wave. Similarly, through testing and analysis involving an example set of conditions that shear horizontal wave in plates is also discovered to have a direct correlation with the rate of crack growth. Thus, other acoustic signals emissions generated or arising from the microcrack should be removed/ignored/deleted with the objective of substantially focusing on symmetric component or the shear horizontal component of the waveform in the detection and determination crack growth rate.

In one or more embodiments of the system and method comprises, one or more acoustic sensors that are positioned on or near a structure(s) (such as a beam, plate, shell, etc.) that is the subject of the system's monitoring and detection. Multiple sensors may be placed in distanced locations to be within reception distance relative to the subject of the monitoring. For example, in the case of an aircraft, the system can have sensors positioned in multiple distanced location near the wing wall to receive acoustic emissions generated by a formation or growth of a microcrack inside the wall. The sensors are configured to receive the acoustic emission and produce an electrical signal that depicts or represents the acoustic emission received at the sensor. This produced signal is generally referred to an acoustic emission signal.

Initial internal microcrack formation and growth of a microcrack are both generally considered microcracks. As mentioned, the sensors are positioned to receive acoustic emission signals generated from cracks internal to the structure. This can occur during active or passive use of the structure being monitored (e.g., an airplane when flying or parked in a hanger). The acoustic signal from a creation of an initial crack or incremental growth of the crack generates an emission signal that includes a symmetric Lamb wave (or symmetric mode) and an asymmetric Lamb wave (or asymmetric mode). The system is configured to sense and determine the symmetric mode of the acoustic emission signal. The system can be configured to detect only symmetric mode signals or filter to retain only the symmetric mode signals in the received signal. The asymmetric mode or substantial portion of it (substantial in that the remaining portion does not materially interfere with the detection using the symmetric mode) can be filtered, removed, minimized, or ignored. The system uses the signal characteristic of the detected symmetric mode to determine the crack growth rate, which represents how an extent of a microcrack formed in the structure that is being monitored. The duration of the crack growth may vary but in general, the activity will reflect a short burst of sound, rising and lowering during that burst time. There may be a series of bursts over time that could be separated by millisecond or hours and the system is configured to detect, determine the crack growth rate for each, and store the information. The data can also be processed to take an action, such as providing an alert.

The system is configured to specify an energy value of the crack from the magnitude of the symmetric mode of the acoustic emission signal. In one or more embodiments, the system can be configured to rectify the symmetric mode of the acoustic emission signal, square (as in the function x²) the rectified signal, and use that rectified acoustic emission signal (using the envelope of the natural burst of the pulse in that mode) to determine a corresponding energy level. The system is configured to use that determined energy level to express the crack growth rate in that incident. The system can be configured (such as by using calibration) to adjust for different types of acoustic emission sensors when implemented.

To further elaborate, it has been discovered that if both symmetric and asymmetric Lamb waves are considered, large errors in the detected acoustic emission energies are found. FIG. 16 depicts the significant errors introduced by in the inclusion of asymmetric mode—the indicated acoustic emission energy from a microcrack close to the surface of beam can be thousands of times larger than the actual energy.

Preferably, the system operates only on (or exclusively uses) the symmetric Lamb wave or shear horizontal wave. If for some reason, other signals are included or combined as input to the stage for determining the crack growth rate via the determining a measurement for the energy emitted from the crack, the other signal(s) should be no greater than +/−10% of the source emission signal used for the determination.

Different types of sensors such as piezoelectric or fiber optic have different characteristics and sensitivity such as to symmetric mode of acoustic emission. The system is configured to adapt the process to each type of sensors to generate a corresponding accurate determination of crack growth. Such sensitives are generally known by those ordinary skilled in the art such as by way of product literature.

The system can be configured to include an algorithm that uses the sensor-received emission signals (and information about the location of the sensors relative to each other) to determine the location of the internal microcrack in the monitored structured. Triangulation techniques or other location determination process are known in the field.

The system can be configured to generate an action in response to the determination such as when the crack growth is above a threshold. The action can for example be an alert notification or an automated action (e.g., a safety action or visual or sound generation) to address the internal crack.

Embodiments of the system and methods of the present invention are preferably configured to continuously monitor a subject structure and detect crack and crack growth rate in real time. In real time, refers to the capability to generate an output instantly when a subject input is received (e.g., a delay up to only few milliseconds).

The system can include a computing device 400 that will perform the described processes. A computer is well known device that includes a Central Processing Unit (“CPU”) 406, memory 412, hardware entities 414 and other attributes such as communications circuitry and software for communicating with sensors, user peripherals (if desired such as keyboard or monitor), networking capability such as to be connect to Ethernet or Internet. Memory 412 and hardware entities 414 can include nonvolatile or non-transitory memory (e.g., hard drive) that stores computer readable instructions 420 that are processed by the computing device 400 to perform steps or operations. Memory 412 can also include random access memory or other temporary memory used for the operation applications.

As shown in FIG. 24, the computing device 400 may comprise a user interface 402, the CPU 406, a system bus 410, the memory 412 connected to and accessible by other portions of computing device 400 through system bus 410, and the hardware entities 414 connected to system bus 410. The user interface may comprise one or more input devices and output devices, which facilitate user-software interactions for controlling operations of the computing device 400. The input devices include, but are not limited to, a physical and/or touch keyboard 450. The input devices can be connected to the computing device 400 via a wired or wireless connection (e.g., a Bluetooth® connection). The output devices may comprise, but are not limited to, a speaker 452, a display 454, and/or light emitting diodes 456.

At least some of the hardware entities 414 may be configured to perform actions involving access to and use of memory 412, which can be a Random Access Memory (RAM), a disk driver and/or a Compact Disc Read Only Memory (CD-ROM), among other suitable memory types. Hardware entities 414 can include a disk drive unit 416 comprising a computer-readable storage medium 418 on which is stored one or more sets of instructions 420 (e.g., programming instructions such as, but not limited to, software code) configured to implement one or more of the methodologies, procedures, or functions described herein. The instructions 420 can also reside, completely or at least partially, within the memory 412 and/or within the CPU 406 during execution thereof by the computing device 400.

The memory 412 and the CPU 406 also can constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 620 for execution by the computing device 400 and that cause the computing device 600 to perform any one or more of the methodologies of the present disclosure. According to various embodiments, one or more computer applications 424 may be stored on the memory 412.

In some embodiments, the computing device 400 can function as a data acquisition device. The data acquisition device can collect the acoustic emission signals from the sensors for analysis. The data acquisition device can also output the acoustic emission signal as a dataset. In some embodiments, the dataset is a numerical dataset. In other embodiments, the data acquisition device can function as the computing device. In some embodiments, a separate data acquisition device and computing device can be used.

It is understood from the above description that the functionality and features of the systems, devices, or methods of embodiments of the present invention include generating and sending signals to accomplish the actions.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention. Applications of the technology to other fields are also contemplated.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

It should be understood that combinations of described features or steps are contemplated even if they are not described directly together or not in the same context.

The terms or words that are used herein are directed to those of ordinary skilled in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

The words “may” and “can” are used in the present description to indicate that this is one embodiment but the description should not be understood to be the only embodiment.

The foregoing merely illustrates the principles of the disclosure. Any examples set forth in this specification are not intended to be limiting and merely set forth some of the many possible embodiments for the appended claims. Those skilled in the art will readily recognize various modifications and changes that may be made without following the example embodiments and applications illustrated and described herein, and without departing from the true spirit and scope of the following claims.

All references cited and/or discussed in this specification are incorporated herein by reference in their entireties and to the same extent as if each reference was individually incorporated by reference.

What is claimed is:

1. A system for monitoring structural integrity, comprising:
a structural member;
one or more acoustic sensors disposed in relation to an area of interest of the structural member, each acoustic sensor configured to:
detect an acoustic emission associated with the area of interest,
produce an acoustic emission signal associated with the acoustic emission, and
output the acoustic emission signal;
a data acquisition device configured to:
collect the acoustic emission signal output by the one or more acoustic sensors, and
output the acoustic emission signal as a dataset;
a computing device, comprising a processor and a memory configured to store programming instructions, wherein the programming instructions, when executed by the processor, are configured to cause the processor to:
receive the dataset into memory,
determine acoustic emission signal characteristics associated with the dataset, and
analyze the acoustic emission signal characteristics to predict whether a crack associated with the structural member is present.

2. The system for monitoring structural integrity of claim 1, wherein the one or more sensors are positioned to receive the acoustic emissions associated with a crack internal to the structural member.

3. The system for monitoring structural integrity of claim 1, wherein each acoustic sensor is disposed at a distance relative to the area of interest.

4. The system for monitoring structural integrity of claim 1, wherein each acoustic sensor is disposed at a distance extending in an angular direction in relation to the area of interest.

5. The system for monitoring structural integrity of claim 4, wherein the angular direction comprises at least one of ninety degrees, sixty-three degrees, or forty-five degrees, each referenced from a horizontal centerline of the area or interest.

6. The system for monitoring structural integrity of claim 1, wherein the one or more acoustic sensors comprise at least one of a piezoelectric material or a fiber optic material.

7. The system for monitoring structural integrity of claim 1, wherein the acoustic emission signal characteristics include a symmetric mode of a Lamb waveform and an antisymmetric mode of the Lamb waveform.

8. The system for monitoring structural integrity of claim 7, wherein the antisymmetric mode is filtered, removed, minimized, or ignored.

9. The system for monitoring structural integrity of claim 1, wherein the acoustic emission signal characteristics includes a shear horizontal waveform.

10. The system for monitoring structural integrity of claim 7, wherein the acoustic emission signal characteristics include an energy value of the crack, the energy value determined from a magnitude of the symmetric mode.

11. The system for monitoring structural integrity of claim 1, wherein the acoustic emission signal characteristics include a symmetric mode of a Lamb waveform associated with the acoustic emission signal, and the computing device is further configured to:
rectify the symmetric mode,
square the rectified symmetric mode,
fit an envelope to the rectified and squared symmetric mode,
determine an area enclosed by the envelope,
correlate the area to an energy value, and
use the energy value to predict growth rate of the crack.

12. The system for monitoring structural integrity of claim 1, wherein the acoustic signal characteristics are used to predict a location of the crack in relation to a reference point of the structural member.

13. The system for monitoring structural integrity of claim 1, wherein the computing device is configured to predict a symmetric mode of a Lamb waveform associated with the acoustic emission signal.

14. The system for monitoring structural integrity of claim 1, wherein the acoustic signal characteristics are used to determine crack growth rate.

15. The system for monitoring structural integrity of claim 1, wherein the computing device is further configured to generate an action in response when characteristics associated with a predicted crack exceed a threshold value.

16. A method for monitoring structural integrity, comprising:
disposing one or more acoustic sensors in relation to an area of interest of a structural member, each acoustic sensor configured to:
detect an acoustic emission associated with the area of interest,
produce an acoustic emission signal associated with the acoustic emission, and
output the acoustic emission signal;
using a data acquisition device configured to:
collect the acoustic emission signal output by the one or more acoustic sensors, and
output the acoustic emission signal as a dataset;
using a computing device, comprising a processor and a memory configured to store programming instructions, wherein the programming instructions, when executed by the processor, are configured to cause the processor to:
receive the dataset into memory,
determine acoustic emission signal characteristics associated with the dataset, and
analyze the acoustic emission signal characteristics to predict whether a crack associated with the structural member is present.

17. The method for monitoring structural integrity of claim 16, wherein the acoustic emission includes a symmetric mode of a Lamb waveform and an antisymmetric mode of the Lamb waveform.

18. The method for monitoring structural integrity of claim 17, wherein the antisymmetric mode is filtered, removed, minimized, or ignored.

19. The method for monitoring structural integrity of claim 16, further comprising using the acoustic signal characteristics to predict a location of the crack in relation to a reference point of the structural member.

20. The method for monitoring structural integrity of claim 16, wherein the acoustic emission signal characteristics include a symmetric mode of a Lamb waveform associated with the acoustic emission signal, and the computing device is further configured to:
rectify the symmetric mode,
square the rectified symmetric mode,
fit an envelope to the rectified and squared symmetric mode,
determine an area enclosed by the envelope,
correlate the area to an energy value, and
use the energy value to predict growth rate of the crack.
